(19) United States
(12) Patent Application Publication
(10) Pub. No.: US 2018/0108022 A1
(43) Pub. Date: Apr. 19, 2018

(54) Increasing Efficiency and Effectiveness of Support Engineers in Resolving Problem Tickets

(71) Applicant: International Business Machines Corporation, Armonk, NY (US)

(72) Inventors: Deborah H. Bandera, Austin, TX (US); Denise A. Bell, Austin, TX (US); Alex D. Little, Raleigh, NC (US); Billy B. York, Pflugerville, TX (US)

(21) Appl. No.: 15/293,988

(22) Filed: Oct. 14, 2016

(51) Int. Cl. G06Q 30/00; G06F 17/30; G06Q 10/06

(52) U.S. Cl. CPC G06Q 30/016; G06Q 10/06316; G06F 17/3053

(57) ABSTRACT

Determining next actions for resolution of a plurality of problem tickets is provided. A set of quantitative metrics corresponding to the plurality of problem tickets is identified. A set of qualitative indicators corresponding to the plurality of problem tickets is identified. Each of the plurality of problem tickets contains textual descriptions of respective problems. The plurality of problem tickets is prioritized based on the set of quantitative metrics and the set of qualitative indicators. A next action to be taken is determined for each of the plurality of problem tickets based on the set of quantitative metrics and the set of qualitative indicators.

### BACKGROUND

### 1. Field

The disclosure relates generally to problem tickets and more specifically to increasing the efficiency and effectiveness of a support engineer in resolving issues corresponding to a plurality of problem tickets by prioritizing the plurality of problem tickets assigned to the support engineer based on identifying and scoring quantitative metrics, qualitative indicators, and customer tones contained in content of respective problem tickets and determining an action step for each respective problem ticket.

### 2. Description of the Related Art

A problem ticket or trouble ticket is a mechanism that an organization may use to track the detection, reporting, and resolution of some type of customer issue with a product or service provided by the organization. Queue management and work prioritization of problem tickets in busy support centers is challenging, especially for problems involving complex hardware or software solutions. Customer satisfaction is greatly influenced by the time it takes to resolve these problems. Unfortunately when support engineers get overloaded with problem tickets, the support engineers may jump back and forth between a number of problem tickets that they are working on and may make little progress on resolving any problem. Also, the support engineers may struggle with determining the next best course of action once they get a chance to focus on a particular problem ticket.

### SUMMARY

According to one illustrative embodiment, a computer-implemented method for determining next actions for resolution of a plurality of problem tickets is provided. A computer identifies a set of quantitative metrics corresponding to the plurality of problem tickets. The computer identities a set of qualitative indicators corresponding to the plurality of problem tickets, wherein each of the plurality of problem tickets contains textual descriptions of respective problems. The computer prioritizes the plurality of problem tickets based on the set of quantitative metrics and the set of qualitative indicators. The computer determines a next action to be taken for each of the plurality of problem tickets based on the set of quantitative metrics and the set of qualitative indicators. According to other illustrative embodiments, a computer system and computer program product for determining next actions for resolution of a plurality of problem tickets are provided.

### BRIEF DESCRIPTION OF THE DRAWINGS

FIG. 1 is a pictorial representation of a network of data processing systems in which illustrative embodiments may be implemented;

FIG. 2 is a diagram of a data processing system in which illustrative embodiments may be implemented;

FIG. 3 is a diagram illustrating an example of a problem ticket management system in accordance with an illustrative embodiment;

FIG. 4 is an example of a graphical user interface in accordance with an illustrative embodiment;

FIG. 5 is an example of a problem ticket in accordance with an illustrative embodiment;

FIGS. 6A-6B are a flowchart illustrating a process for populating a dashboard with a prioritized list of problem tickets and corresponding action steps in accordance with an illustrative embodiment; and

FIG. 7 is a flowchart illustrating a process for performing an automated action step in accordance with an illustrative embodiment.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

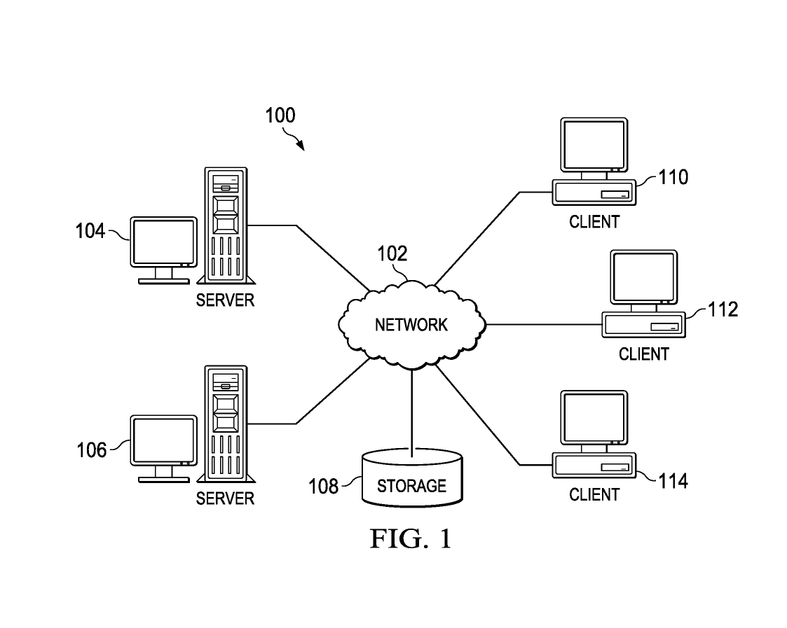

With reference now to the figures, and in particular, with reference to FIGS. 1-3, diagrams of data processing environments are provided in which illustrative embodiments may be implemented. It should be appreciated that FIGS. 1-3 are only meant as examples and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers, data processing systems, and other devices in which the illustrative embodiments may be implemented. Network data processing system 100 contains network 102, which is the medium used to provide communications links between the computers, data processing systems, and other devices connected together within network data processing system 100. Network 102 may include connections, such as, for example, wire communication links, wireless communication links, and fiber optic cables.

In the depicted example, server 104 and server 106 connect to network 102, along with storage 108. Server 104 and server 106 may be, for example, server computers with high-speed connections to network 102. Server 104 and server 106 may provide a set of services to users of client devices connected to network 102. For example, server 104 and server 106 may provide problem ticket prioritization services to client device users. Server 104 and server 106 may perform these problem ticket prioritization services by performing an analysis of quantitative metrics, qualitative indicators, and customer tones contained within content of respective problem tickets and listing the problem tickets in a priority order based on the analysis. Further, server 104 and server 106 may determine a next action step for each respective problem ticket for client device users. Also, it should be noted that server 104 and server 106 may represent a plurality of different servers providing a plurality of different problem ticket prioritization services.

Client 110, client 112, and client 114 also connect to network 102. Clients 110, 112, and 114 are clients of server 104 and server 106. Clients 110, 112, and 114 may represent a plurality of workstations corresponding to a plurality of different users. The users may be, for example, support engineers assigned to resolve issues corresponding to the problem tickets. Further, server 104 and server 106 may provide information, such as boot files, operating system images, and software applications to clients 110, 112, and 114.

In this example, clients 110, 112, and 114 are illustrated as desktop or personal computers with wire or wireless communication links to network 102. However, it should be noted that clients 110, 112, and 114 are meant as examples only. In other words, clients 110, 112, and 114 may include other types of data processing systems, such as, for example, laptop computers, handheld computers, smart phones, personal digital assistants, and the like. Users of clients 110, 112, and 114 may utilize clients 110, 112, and 114 to access the problem ticket prioritization services provided by server 104 and server 106. In addition, users of clients 110, 112, and 114 may utilize clients 110, 112, and 114 to communicate with customers corresponding to the problem tickets.

Storage 108 is a network storage device capable of storing any type of data in a structured format or an unstructured format. in addition, storage 108 may represent a set of one or more network storage devices. Storage 108 may store, for example, names and identification information for a plurality of different users (e.g., support engineers); a plurality of problem tickets; problem ticket assignments to the plurality of users; problem ticket quantitative metrics; problem ticket qualitative indicators; problem ticket customer tones, problem ticket scores, and the like. Further, storage 108 also may store other data, such as authentication or credential data that may include user names, passwords, and biometric data associated with the plurality of different users and system administrators, for example.

In addition, it should be noted that network data processing system 100 may include any number of additional server devices, client devices, and other devices not shown, such as customer data processing system devices. Program code located in network data processing system 100 may be stored on a computer readable storage medium and downloaded to a computer or data processing system for use. For example, program code may be stored on a computer readable storage medium on server 104 and downloaded to client 110 over network 102 for use on client 110.

In the depicted example, network data processing system 100 may be implemented as a number of different types of communication networks, such as, for example, an internet, an intranet, a local area network (LAN), a wide area network (WAN), or any combination thereof. FIG. 1 is intended as an example, and not as an architectural limitation for the different illustrative embodiments.

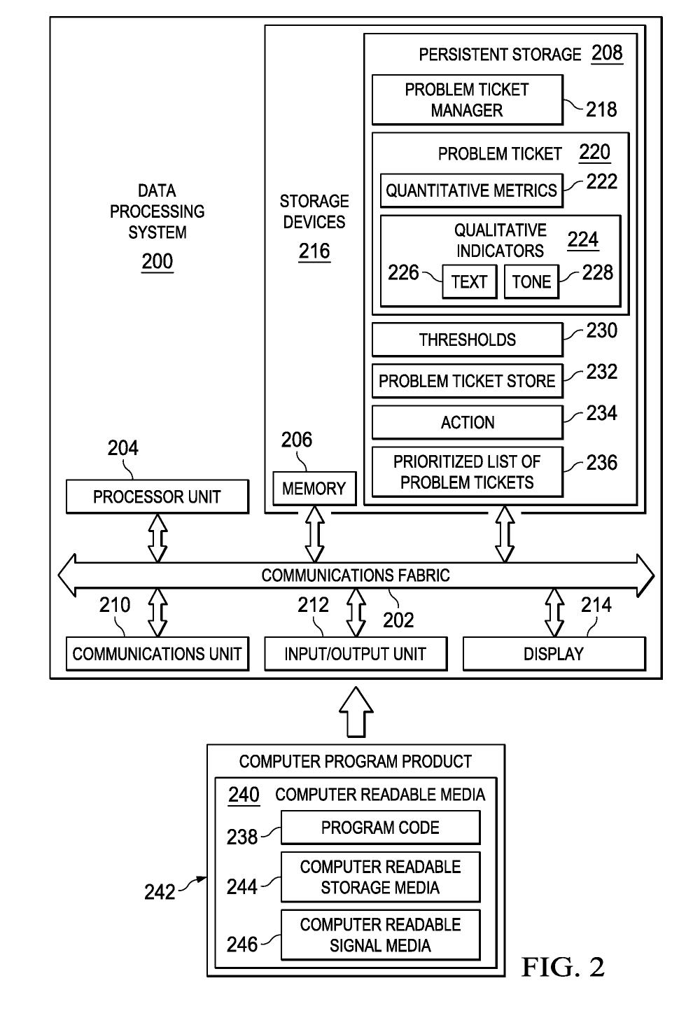

With reference now to FIG. 2, a diagram of a data processing system is depicted in accordance with an illustrative embodiment. Data processing system 200 is an example of a computer, such as server 104 in FIG. 1, in which computer readable program code or program instructions implementing processes of illustrative embodiments may be located. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software applications and programs that may be loaded into memory 206. Processor unit 204 may be a set of one or more hardware processor devices or may be a multi-processor core, depending on the particular implementation. Further, processor unit 204 may be implemented using one or more heterogeneous processor systems, in which a main processor is present with secondary processors on a single chip. As another illustrative example, processor unit 204 may be a symmetric multi-processor system containing multiple processors of the same type.

Memory 206 and persistent storage 208 are examples of storage devices 216. A computer readable storage device is any piece of hardware that is capable of storing information, such as, for example, without limitation, data, computer readable program code in functional form, and/or other suitable information either on a transient basis and/or a persistent basis. Further, a computer readable storage device excludes a propagation medium. Memory 206, in these examples, may be, for example, a random access memory, or any other suitable volatile or non-volatile storage device. Persistent storage 208 may take various forms, depending on the particular implementation. For example, persistent storage 208 may contain one or more devices. For example, persistent storage 208 may be a hard drive, a flash memory, a rewritable optical disk, a rewritable magnetic tape, or some combination of the above. The media used by persistent storage 208 may be removable. For example, a removable hard drive may be used for persistent storage 208.

In this example, persistent storage 208 stores problem ticket manager 218. Problem ticket manager 218 controls the process of prioritizing problem tickets assigned to a support engineer based on identifying and scoring quantitative metrics, qualitative indicators, and customer tones contained within content of respective problem tickets. In addition, problem ticket manager 218 determines a next action step for each respective problem ticket in the prioritized list of problem tickets and displays each action step with respective problem tickets in the prioritized list within a graphical user interface for review by the support engineer.

It should be noted that even though problem ticket manager 218 is illustrated as residing in persistent storage 208, in an alternative illustrative embodiment problem ticket manager 218 may be a separate component of data processing system 200. For example, problem ticket manager 218 may be a hardware component coupled to communication fabric 202 or a combination of hardware and software components. In another alternative illustrative embodiment, problem ticket manager 218 may be located in a support engineer workstation, such as client 110 in FIG. 1. In yet another alternative illustrative embodiment, a first portion of the components of problem ticket manager 218 may be located in data processing system 200 and a second portion of the components may be located in the support engineer workstation.

Problem ticket manager 218 analyzes problem ticket 220 to identify quantitative metrics 222 and qualitative indicators 224 contained within problem ticket 220. Quantitative metrics 222 represent a set of numerical values contained in problem ticket 220. For example, quantitative metrics 222 may include, for example, a severity level value corresponding to problem ticket 220; a number of days value indicating the age of problem ticket 220 with no resolution; a number of days value indicating the last time a customer associated with problem ticket 220 has been contacted by the support engineer; a number of days value in which the customer has not responded to requests for information corresponding to problem ticket 220; a period of time value in which the customer uploaded new information or documents corresponding to problem ticket 220; and a period of time value in which the customer has sent a new communication asking a new question corresponding to problem ticket 220; and the like.

Qualitative indicators 224 represent a set of textual information and/or expressed customer tones contained in problem ticket 220. Qualitative indicators 224 include text 226 and tone 228. Text 226 represents a specific set of information contained in problem ticket 220. Problem ticket manager 218 may utilize, for example, text analytics or natural language processing to identify text 226. Tone 228 represents a specific set of customer tones contained within problem ticket 220. Problem ticket manager 218 may utilize, for example, a tone analyzer to identify tone 228.

Qualitative indicators 224 contained in problem ticket 220 may include, for example, a customer asking for an update corresponding to problem ticket 220; the customer is indicating that a deadline for resolving problem ticket 220 is approaching; the customer is asking for a manager; the customer is requesting a remote session associated with problem ticket 220; the support engineer is waiting for updates associated with problem ticket 220 from a development team; the customer is indicating that the production system is down; the customer is indicating an application outage; the customer is threatening antagonistic action; the customer is requesting escalation of problem ticket 220 to a “critical situation” level; the customer is using expletives, swearwords, or harsh tones in a communication corresponding to problem ticket 220; and the like. Qualitative indicators 224 contained in problem ticket 220 also may include angry customer tones, frustrated customer tones, disgusted customer tones, irritated customer tones, harsh customer tones, and the like.

Thresholds 230 represent a set of threshold level values. Thresholds 230 may include, for example, a set of one or more quantitative metric threshold values and a set of one or more customer tone threshold values. Problem ticket manager 218 utilizes thresholds 230 to determine whether one or more of quantitative metrics 222 contained in problem ticket 220 exceed a predefined metric threshold value and to determine whether one or more customer tones in tone 228 exceed a predefined tone threshold value.

Problem ticket score 232 represents a numeric value corresponding to problem ticket 220. Problem ticket manager 218 generates problem ticket score 232 based on problem ticket manager awarding one point to problem ticket 220 for each quantitative metric and each qualitative indicator identified in problem ticket 220 and adding all the awarded points together.

Action 234 represents a next action step associated with problem ticket 220. Problem ticket manager 218 recommends action 234 based on quantitative metrics 222 and qualitative indicators 224 identified in problem ticket 220. Action 234 may include, for example, support engineer to call the customer; support engineer to review recently received documents or information from customer; support engineer to schedule a remote session with the customer; support engineer to send an alert to a manager; support engineer to request assistance from team leader or subject matter expert; support engineer to call development team for an update; support engineer to contact the customer regarding results of the analysis of the customer's problem; support engineer to email the customer links to documentation regarding the customer's problem; support engineer to email the customer with an answer to the customer's recently submitted question; and the like.

Problem ticket manager 218 places problem ticket 220 in prioritized list of problem tickets 236 based on problem ticket score 232. In other words, prioritized list of problem tickets 236 is a list of problem tickets in a priority order from highest priority to lowest based on respective scores. In addition, problem ticket manager 218 includes a recommended action step, such as action 234, with each respective problem ticket in prioritized list of problem tickets 236.

Communications unit 210, in this example, provides for communication with other computers, data processing systems, and mixed reality devices via a network, such as network 102 in FIG. 1. Communications unit 210 may provide communications using both physical and wireless communications links. The physical communications link may utilize, for example, a wire, cable, universal serial bus, or any other physical technology to establish a physical communications link for data processing system 200. The wireless communications link may utilize, for example, shortwave, high frequency, ultra high frequency, microwave, wireless fidelity (WiFi), bluetooth technology, global system for mobile communications (GSM), code division multiple access (CDMA), second-generation (2G), third-generation (3G), fourth-generation (4G), 4G Long Term Evolution (LTE), LTE Advanced, or any other wireless communication technology or standard to establish a wireless communications link for data processing system 200.

Input/output unit 212 allows for the input and output of data with other devices that may be connected to data processing system 200. For example, input/output unit 212 may provide a connection for user input through a game controller, hand gesture detector, keypad, keyboard, and/or some other suitable input device. Display 214 provides a mechanism to display information to a user and may include touch screen capabilities to allow the user to make on-screen selections through user interfaces or input data, for example.

Instructions for the operating system, applications, and/or programs may be located in storage devices 216, which are in communication with processor unit 204 through communications fabric 202. In this illustrative example, the instructions are in a functional form on persistent storage 208. These instructions may be loaded into memory 206 for running by processor unit 204. The processes of the different embodiments may be performed by processor unit 204 using computer implemented program instructions, which may be located in a memory, such as memory 206. These program instructions are referred to as program code, computer usable program code, or computer readable program code that may be read and run by a processor in processor unit 204. The program code, in the different embodiments, may be embodied on different physical computer readable storage devices, such as memory 206 or persistent storage 208.

Program code 238 is located in a functional form on computer readable media 240 that is selectively removable and may be loaded onto or transferred to data processing system 200 for running by processor unit 204. Program code 238 and computer readable media 240 form computer program product 242. In one example, computer readable media 240 may be computer readable storage media 244 or computer readable signal media 246. Computer readable storage media 244 may include, for example, an optical or magnetic disc that is inserted or placed into a drive or other device that is part of persistent storage 208 for transfer onto a storage device, such as a hard drive, that is part of persistent storage 208. Computer readable storage media 244 also may take the form of a persistent storage, such as a hard drive, a thumb drive, or a flash memory that is connected to data processing system 200. In some instances, computer readable storage media 244 may not be removable from data processing system 200.

Alternatively, program code 238 may be transferred to data processing system 200 using computer readable signal media 246. Computer readable signal media 246 may be, for example, a propagated data signal containing program code 238. For example, computer readable signal media 246 may be an electro-magnetic signal, an optical signal, and/or any other suitable type of signal. These signals may be transmitted over communication links, such as wireless communication links, an optical fiber cable, a coaxial cable, a wire, and/or any other suitable type of communications link. In other words, the communications link and/or the connection may be physical or wireless in the illustrative examples. The computer readable media also may take the form of non-tangible media, such as communication links or wireless transmissions containing the program code.

In some illustrative embodiments, program code 238 may be downloaded over a network to persistent storage 208 from another device or data processing system through computer readable signal media 246 for use within data processing system 200. For instance, program code stored in a computer readable storage media in a data processing system may be downloaded over a network from the data processing system to data processing system 200. The data processing system providing program code 238 may be a server computer, a client computer, or some other device capable of storing and transmitting program code 238.

The different components illustrated for data processing system 200 are not meant to provide architectural limitations to the manner in which different embodiments may be implemented. The different illustrative embodiments may be implemented in a data processing system including components in addition to, or in place of, those illustrated for data processing system 200. Other components shown in FIG. 2 can be varied from the illustrative examples shown. The different embodiments may be implemented using any hardware device or system capable of executing program code. As one example, data processing system 200 may include organic components integrated with inorganic components and/or may be comprised entirely of organic components excluding a human being. For example, a storage device may be comprised of an organic semiconductor.

As another example, a computer readable storage device in data processing system 200 is any hardware apparatus that may store data. Memory 206, persistent storage 208, and computer readable storage media 244 are examples of physical storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modern or a network adapter. Further, a memory may be, for example, memory 206 or a cache such as found in an interface and memory controller hub that may be present in communications fabric 202.

Illustrative embodiments combine quantitative analysis of problem ticket metrics with qualitative analysis of the contents of problem tickets to add more initiative in prioritizing the support engineers' work queues. In addition, illustrative embodiments make recommendations of next action steps to be taken by support engineers to make progress on the problem tickets and maintain or increase customer satisfaction. Illustrative embodiments combine quantitative analysis with factors that are only available by analyzing the actual text contained in the problem record.

Using text analytics, illustrative embodiments are able to identify possible consequences to the customer, which may not be apparent by just looking at the problem severity. For example, a customer may open a problem ticket as a severity level rating of 2 or 3 even though the customer may have a critical deadline approaching because the problem does not meet the level 1 severity criteria of a production system being down. Illustrative embodiments would prioritize that particular problem ticket above a severity 1 problem ticket that a support engineer is already making progress on. Thus, one benefit of illustrative embodiments is that they may help prioritize the support engineer's work day. As a result, illustrative embodiments may reduce support engineer thrashing from one problem ticket to another and may ensure that support engineers first support customers with high priority problems.

Problems at a middle severity level can take a support engineer team by surprise with a sudden escalation in severity. Illustrative embodiments can reduce or prevent these unexpected escalations due to poor problem ticket hygiene, such as, for example, customer not contacted for days, problem ticket bouncing, project deadline approaching, and the like.

To prioritize the problem tickets, illustrative embodiments utilize an algorithm that combines scores from each of these three categories: 1) quantitative metrics; 2) qualitative indicators; and 3) customer tones. Illustrative embodiments award one (1) point for each of these items that is true.

Quantitative metrics that illustrative embodiments monitor and identify may include, for example: a defined severity level (e.g., severity level 1); overall age of a problem ticket (e.g., over 14 days old) with no resolution yet; problem tickets in which the customer has not been contacted by a support engineer in a number of days (e.g., 5 days); problem tickets in which the customer has not responded to requests for information for a certain number of days (e.g., 7 days); problem tickets that have been escalated in severity level since the last analysis (e.g., escalated up one or more levels in severity); problem tickets where the customer has uploaded new information or documents (e.g., logs or traces) within a predefined period of time (e.g., the last 24 hours); and problem tickets where the customer has sent a new communication (e.g., an email or text message) asking a new question within a predefined period of time (e.g., the last 24 hours). Illustrative embodiments award one (1) point for each of these conditions that is satisfied (i.e., a condition that is greater than or equal to a defined metric threshold corresponding to that condition).

Illustrative embodiments also gather qualitative indicators via text analytics or natural language processing, for example. Using qualitative analytics on the content of problem tickets, illustrative embodiments identify problem tickets where the most recent entry may contain, for example, one of the following indicators: customer asks for an update; customer indicates that a deadline is approaching; customer asks for a manager; customer requests a remote session; support engineer is waiting for updates from development team; customer indicates that the production system is down; customer indicates an application outage; customer threatens antagonistic action (e.g., deleting the software package from the customer's computer system); customer requests escalation to a “critical situation” level; or customer uses expletives, swearwords, or harsh tones in a communication. Illustrative embodiments award 1 point for each of these situations that is true. For each of these situations a defined set of text exists, such as, for example, a set of keywords and phrases, which illustrative embodiments monitor for and identify in the content of problem tickets. Over time, illustrative embodiments may utilize artificial intelligence to further tune the process to better identify these problematic situations and expand the defined set of text,

In addition, illustrative embodiments may customize the list of qualitative indicators over time as illustrative embodiments identify additional indicators. Illustrative embodiments also may utilize a tone analyzer as another input to the problem ticket prioritization algorithm. For problem tickets that have a higher tone rating for frustration, anger, disgust, irritation, and the like, illustrative embodiments may prioritize these problem tickets over those problem tickets in which the customer's tone or mood is softer or calmer. For example, illustrative embodiments may award 1 point to problem tickets with an angry tone rating greater than seventy five percent or award 1 point to problem tickets with a disgusted tone rating greater than seventy five percent.

Using this quantitative and qualitative information, illustrative embodiments generate a graphical user interface dashboard or priority list that prioritizes the support engineer's or support team's problem ticket workload for the day. Illustrative embodiments add the points from each category together and prioritize the problem tickets from highest score (i.e., most urgent problem ticket to deal with) to the lowest score (i.e., least urgent problem ticket to deal with). Illustrative embodiments provide this prioritized list of problem tickets to be worked on in the dashboard and also provide a recommended next action step for each problem ticket in the list.

Illustrative embodiments may perform this problem ticket analysis on a predetermined time interval basis, such as, for example, on an hourly basis, a bi-daily basis, a daily basis, weekly basis, or any other time interval basis. Alternatively, illustrative embodiments may perform the problem ticket analysis on demand so that the support engineer may determine how frequently the support engineer's list of problem tickets is to be re-prioritized.

For problem tickets that scored higher than a predefined threshold level value, illustrative embodiments may recommend engaging a manager as a suggested next action step, for example. Other examples of suggested next action steps may include: support engineer to call the customer; support engineer to review recently received documents or information from customer; support engineer to schedule a remote session with the customer; support engineer to send an alert to a manager; support engineer to request assistance from team leader or subject matter expert; support engineer to call development team for an update; support engineer to contact the customer regarding results of the analysis of the customer's problem; support engineer to email the customer links to documentation regarding the customer's problem; support engineer to email the customer with an answer to the customer's new question; and the like.

However, it should be noted that illustrative embodiments may automatically perform action steps. For example, illustrative embodiments may automatically send a. communication to a customer regarding escalation of the customer's problem ticket in response to illustrative embodiments escalating the problem ticket to a severity level 1. Illustrative embodiments also may automatically send updated information to the customer in response to receiving a request from the customer for an update. Further, illustrative embodiments may automatically acknowledge receipt of new documents or information recently submitted by the customer. Furthermore, illustrative embodiments may automatically analyze the recently submitted documents or information from the customer to automatically calculate the priority level of the corresponding problem ticket. Moreover, illustrative embodiments may automatically schedule a follow up session or remote session after consulting an electronic calendar corresponding to the support engineer. In addition, illustrative embodiments may automatically contact the customer to ask if the issue corresponding to the problem ticket has been resolve if the customer has not responded in 7 days, for example.

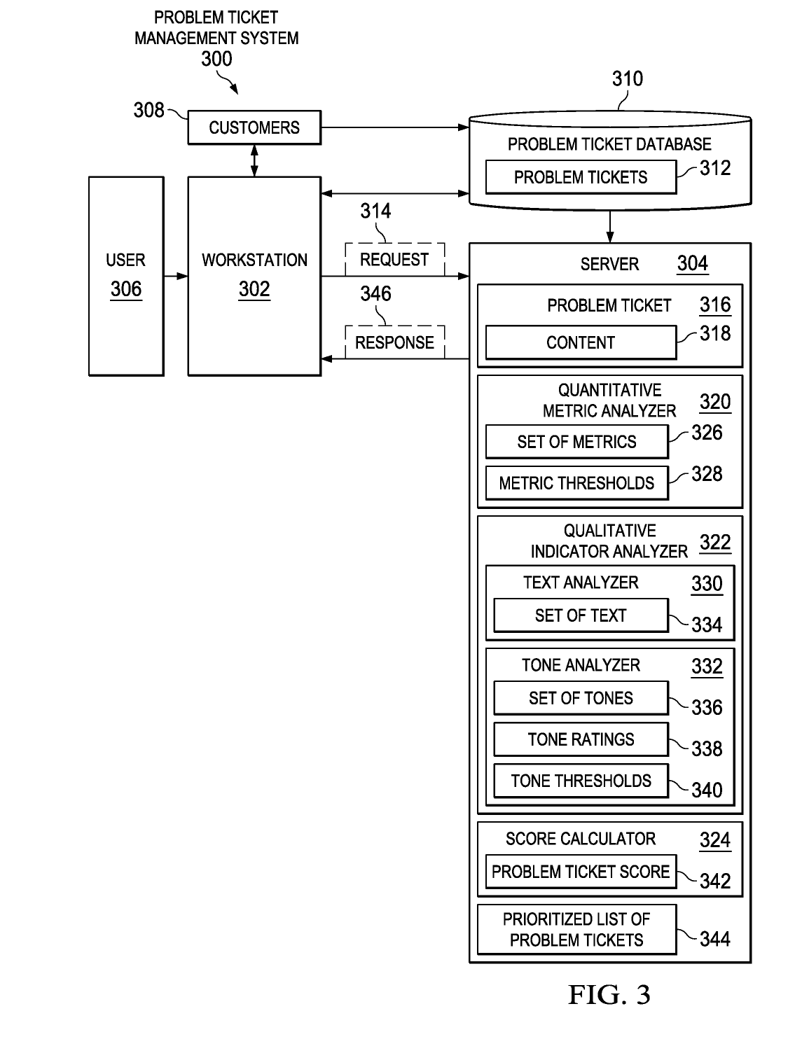

With reference now to FIG. 3, a diagram illustrating an example of a problem ticket management system is depicted in accordance with an illustrative embodiment. Problem ticket management system 300 is a combination of hardware and software components for prioritizing problem tickets assigned to a support engineer based on identifying quantitative metrics, qualitative indicators, and customer tones contained within content of respective problem tickets and determining a next action step for each respective problem ticket in the prioritized list of problem tickets. Problem ticket management system 300 may be implemented in a network of data processing systems, such as, for example, network data processing system 100 in FIG. 1.

In this example, problem ticket management system 300 includes workstation 302 and server 304. Workstation 302 may be, for example, client 110 in FIG. 1. Server 304 may be, for example, server 104 in FIG. 1 or data processing system 200 in FIG. 2. User 306 utilizes workstation 302 to communicate with customers 308, problem ticket database 310, and server 304. User 306 may be, for example, a support engineer who is assigned problem tickets 312 for resolution. Customers 308 represent a plurality of different customers that correspond to different problem tickets in problem tickets 312. Problem tickets 312 represent different issues experienced by customers 308 with products or services provided by a company or enterprise.

User 306 utilizes workstation 302 to send request 314 to server 304. Request 314 represents a request to prioritize problem tickets 312, which are assigned to user 306. In response to receiving request 314, server 304 retrieves problem tickets 312 from problem ticket database 310. Then, server 304 selects a problem ticket, such as problem ticket 316, from problem tickets 312. Problem ticket 316 contains content 318. Content 318 represents information, such as documents, logs, communications, reports, and any other similar data, corresponding to an issue experienced by a particular customer in customers 308.

Server 304 utilizes quantitative metric analyzer 320 and qualitative indicator analyzer 322 to analyze content 318 of problem ticket 316 to identify quantitative metrics and qualitative indicators contained within content 318. In addition, server 304 utilizes score calculator 324 to calculate an aggregate score for problem ticket 316.

It should be noted that quantitative metric analyzer 320 and qualitative indicator analyzer 322 may be components of a natural language processing system configured to analyze textual information contained within content 318 of problem ticket 316 in accordance with illustrative embodiments of the present disclosure. In some embodiments, a remote device corresponding to a customer may submit problem ticket 316 containing issues with a product to be analyzed by the natural language processing system. Consistent with various embodiments, the natural language processing system may respond to problem ticket submissions sent by customers. Specifically, the natural language processing system may analyze problem ticket 316 to aid in the analysis of issues with the product for support engineer consideration. In some embodiments, the natural language processing system may include a natural language processor, data sources, a rank notifier, and a sentiment ranker module.

The natural language processor may be a computer module that analyzes problem ticket 316 and other electronic documents. The natural language processor may perform various methods and techniques for analyzing problem ticket 316 and the other electronic documents (e.g., syntactic analysis, semantic analysis, et cetera). The natural language processor may be configured to recognize and analyze any number of natural languages. In some illustrative embodiments, the natural language processor may parse passages of the documents. Further, the natural language processor may include various modules to perform analyses of product tickets. These modules may include, but are not limited to, a tokenizer, a part-of-speech (POS) tagger, a semantic relationship identifier, a syntactic relationship identifier, and sentiment analyzer.

In some illustrative embodiments, the tokenizer may be a computer module that performs lexical analysis. The tokenizer may convert a sequence of characters into a. sequence of tokens. A token may be a string of characters included in an electronic document and categorized as a meaningful symbol. Further, in some illustrative embodiments, the tokenizer may identify word boundaries in an electronic document and break any text passages within the document into their component text elements, such as words, multiword tokens, numbers, and punctuation marks. In some illustrative embodiments, the tokenizer may receive a string of characters, identify the lexemes in the string, and categorize them into tokens.

Consistent with various illustrative embodiments, the POS tagger may be a computer module that marks up a word in passages to correspond to a particular part of speech. The POS tagger may read a passage or other text in natural language and assign a part of speech to each word or other token. The POS tagger may determine the part of speech to which a word (or other text element) corresponds based on the definition of the word and the context of the word. The context of a word may be based on its relationship with adjacent and related words in a phrase, sentence, or paragraph. In some illustrative embodiments, the context of a word may be dependent on one or more previously analyzed electronic documents (e.g., the content of one problem ticket may shed light on the meaning of text elements in another problem ticket, particularly if they are problem tickets that relate to the same product). Examples of parts of speech that may be assigned to words include, but are not limited to, nouns, verbs, adjectives, adverbs, and the like. Examples of other part of speech categories that POS tagger may assign include, but are not limited to, comparative or superlative adverbs, wh-adverbs, conjunctions, determiners, negative particles, possessive markers, prepositions, wh-pronouns, and the like. In some illustrative embodiments, the POS tagger may tag or otherwise annotate tokens of a passage with part of speech categories. In some illustrative embodiments, the POS tagger may tag tokens or words of a passage to be parsed by other components of the natural language processing system.

In some illustrative embodiments, the semantic relationship identifier may be a computer module that is configured to identify semantic relationships of recognized text elements (e.g., words, phrases) in documents. In some illustrative embodiments, the semantic relationship identifier may determine functional dependencies between entities and other semantic relationships.

Consistent with various illustrative embodiments, the syntactic relationship identifier may be a computer module that is configured to identify syntactic relationships in a passage composed of tokens. The syntactic relationship identifier may determine the grammatical structure of sentences such as, for example, which groups of words are associated as phrases and which word is the subject or object of a verb. The syntactic relationship identifier may conform to formal grammar.

Consistent with various illustrative embodiments, the sentiment analyzer may be a computer module that is configured to identify and categorize the sentiments associated with tokens of interest. In some illustrative embodiments, the sentiment analyzer may be configured to identify, within text passages, and annotate keywords that are preselected as high quality indicators of sentiment polarity (e.g., indicators of positive sentiment could include brilliant, excellent, or fantastic). Various tools and algorithms may be used by the sentiment analyzer as are known to those skilled in the art (e.g., Naïve Bayes lexical model).

In some illustrative embodiments, the natural language processor may be a computer module that may parse a document and generate corresponding data structures for one or more portions of the document. For example, in response to receiving a set of problem tickets by the natural language processing system, the natural language processor may output parsed text elements from the problem tickets as data structures. In some illustrative embodiments, a parsed text element may be represented in the form of a parse tree or other graph structure. To generate the parsed text element, the natural language processor may trigger the tokenizer, POS tagger, semantic relationship identifier, syntactic relationship identifier, and sentiment analyzer computer modules.

In some illustrative embodiments, the output of the natural language processor may be stored as an information corpus in one or more data sources. In some illustrative embodiments, the data sources may include data warehouses, information corpora, data models, and document repositories. The information corpus may enable data storage and retrieval. In some illustrative embodiments, the information corpus may be a storage mechanism that houses a standardized, consistent, clean, and integrated copy of the ingested and parsed problem tickets. Data stored in the information corpus may be structured in a way to specifically address analytic requirements. For example, the information corpus may store the ingested problem tickets based on groups of related products (e.g., products of the same type). In some illustrative embodiments, the information corpus may be a relational database.

In some illustrative embodiments, the natural language processing system may include a sentiment ranker module. The sentiment ranker module may be a computer module that is configured to generate sentiment scores for specific forms of problem tickets based on the analysis of annotated problem tickets. The sentiment ranker module may be further configured to rank or rate the problem tickets based on these sentiment scores.

The rank notifier may be a computer module that is configured to notify users, such as support engineers of problem ticket rankings determined by the sentiment ranker module. In some illustrative embodiments, the rank notifier may communicate with a rank notification receiver module.

In this example, quantitative metric analyzer 320 includes set of metrics 326 and metric thresholds 328 Set of metrics 326 represent a predefined set of one or more quantitative metrics. Quantitative metric analyzer 320 uses set of metrics 326 to identify particular metric values contained in content 318 of problem ticket 316. Metric thresholds 328 represent a predefined set of one or more quantitative metric threshold values. Quantitative metric analyzer 320 uses metric thresholds 328 to identify those metrics in set of metrics 326 that exceed a set metric threshold value. Quantitative metric analyzer 320 awards one point to problem ticket 316 for each quantitative metric contained within content 318 that exceeds a set metric threshold value in metric thresholds 328.

In this example, qualitative indicator analyzer 322 includes text analyzer 330 and tone analyzer 332. Qualitative indicator analyzer 322 utilizes text analyzer 330 to analyze the textual information contained within content 318. Text analyzer 330 may employ, for example, text analytics and/or natural language processing to analyze the textual information. Text analyzer includes set of text 334. Set of text 334 represents a predefined set of words and phrases. Text analyzer 330 uses set of text 334 to identify those words and phrases contained within content 318 that may indicate a potential customer issue.

Qualitative indicator analyzer 322 utilizes tone analyzer 332 to analyze the expressed customer tones contained within content 318. Tone analyzer includes set of tones 336, tone ratings 338, and tone thresholds 340. Set of tones 336 represent a predefined set of one or more customer tones, such as anger, frustration, and irritation. Tone analyzer 332 uses set of tones 336 to identify those customer tones contained within content 318 that may indicate a potential customer issue.

Tone ratings 338 represent a rating level value for identified customer tones. Tone analyzer 332 generates a tone rating for each identified customer tone in content 318. In addition, tone analyzer 332 compares each generated tone rating with tone thresholds 340. If a tone rating of an identified customer tone exceeds a set threshold value in tone thresholds 340, then tone analyzer 332 awards one point to problem ticket 316.

Score calculator 324 adds together all the awarded points corresponding to problem ticket 316 to generate problem ticket score 342 for problem ticket 316. In other words, problem ticket score 342 represents an aggregate score for problem ticket 316. Server 304 then places problem ticket 316 in prioritized list of problem tickets 344 in priority order with other problem tickets based on problem ticket score 342 corresponding to problem ticket 316. Server 304 repeats this process for each problem ticket in problem tickets 312 assigned to user 306. Further, server 304 may determine a next action step for each problem ticket and insert the next action step with each respective problem ticket in prioritized list of problem tickets 344. Furthermore, server 304 may perform one or more of the action steps automatically.

Server 304 sends prioritized list of problem tickets 344 to workstation 302 in response 346. User 306 uses prioritized list of problem tickets 344 to increase the efficiency and effectiveness of user 306 in resolving issues corresponding to problem tickets 312.

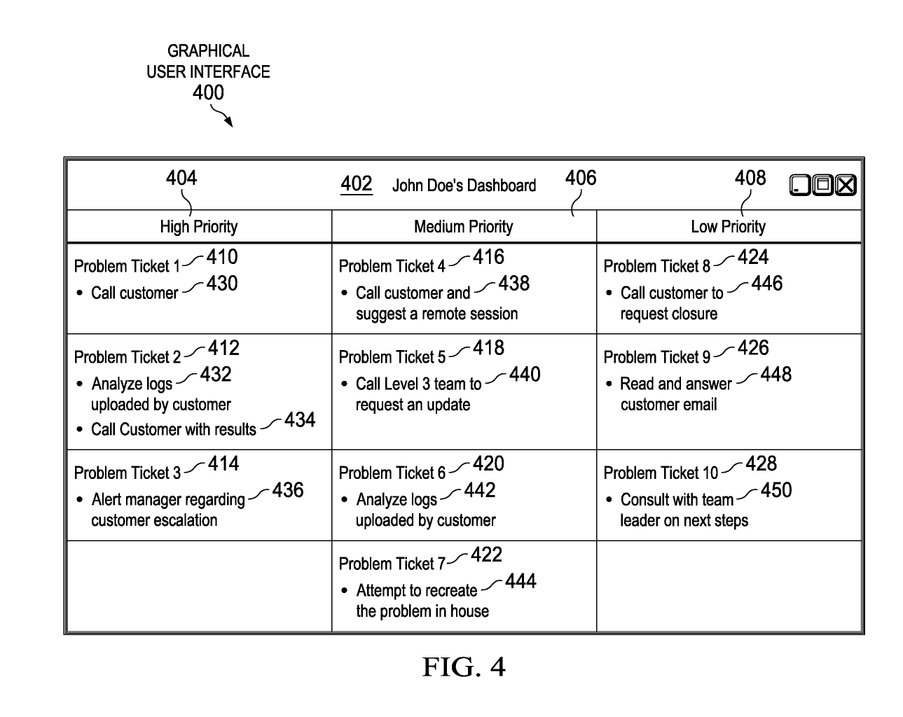

With reference now to FIG. 4, an example of a graphical user interface is depicted in accordance with an illustrative embodiment. Illustrative embodiments may display graphical user interface 400 in a support engineer's workstation, such as workstation 302 in FIG. 3. Graphical user interface 400 includes dashboard 402. Dashboard 402 represents a prioritized display of problem tickets assigned to a particular support engineer, such as John Doe in this example. Illustrative embodiments may update dashboard 402 on a predefined time interval basis, such as, for example, daily, or on demand.

In this example, dashboard 402 includes high priority 404, medium priority 406, and low priority 408. High priority 404 represents a section of dashboard 402 that includes high priority problem tickets, such as problem ticket 1 410, problem ticket 2 412, and problem ticket 3 414. Medium priority 406 represents a section of dashboard 402 that includes medium priority problem tickets, such as problem ticket 4 416, problem ticket 5 418, problem ticket 6 420, and problem ticket 7 422. Low priority 408 represents a section of dashboard 402 that includes low priority problem tickets, such as problem ticket 8 424, problem ticket 9 426, and problem ticket 10 428. Problem tickets 410-428 may be, for example, problem tickets listed in a prioritized list of problem tickets, such as prioritized list of problem tickets 344 in FIG. 3.

Also in this example, dashboard 402 includes a recommended next action step with each respective problem ticket in problem tickets 410-428. For example, problem ticket 1 410 has recommended next action step 430 of “call customer”. Problem ticket 2 412 has recommended next action step 432 of “analyze logs uploaded by customer” and recommended next action step 434 of “call customer with results”. Problem ticket 3 414 has recommended next action step 436 of “alert manager regarding customer escalation”. Problem ticket 4 416 has recommended next action step 438 of “call customer and suggest a remote session”. Problem ticket 5 418 has recommended next action step 440 of “call level 3 team to request an update”. Problem ticket 6 420 has recommended next action step 442 of “analyze logs uploaded by customer”. Problem ticket 7 422 has recommended next action step 444 of “attempt to recreate the problem in house”. Problem ticket 8 424 has recommended next action step 446 of “call customer to request closure”. Problem ticket 9 426 has recommended next action step 448 of “read and answer customer email”. Problem ticket 10 428 has recommended next action step 450 of “consult with team leader on next steps”.

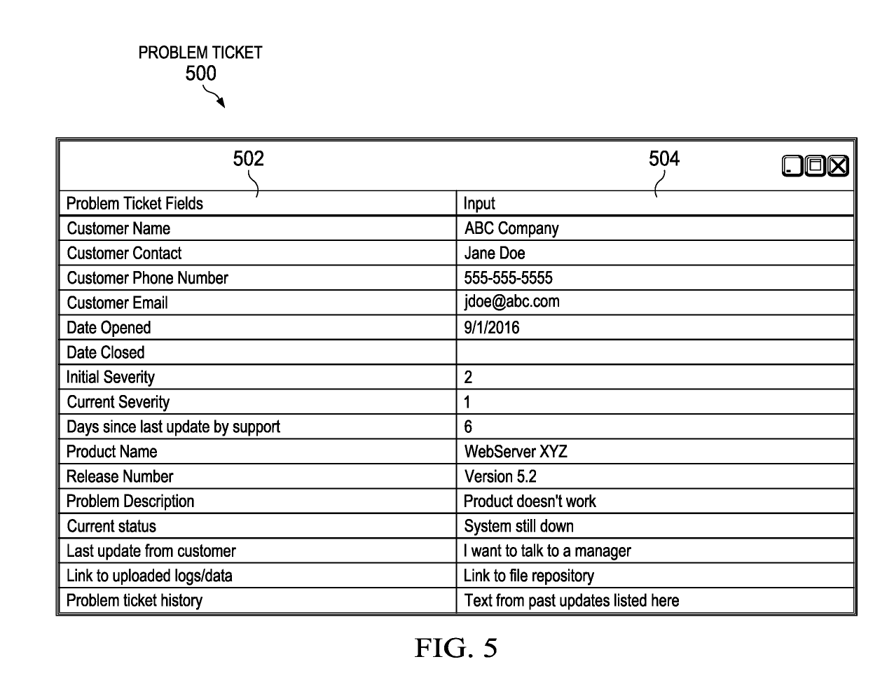

With reference now to FIG. 5, an example of a problem ticket is depicted in accordance with an illustrative embodiment. Problem ticket 500 may be, for example, problem ticket 316 in FIG. 3. In this example, problem ticket 500 includes problem ticket fields 502 and input 504. Problem ticket fields 502 represent a plurality of different data field items, such as, for example, customer name, customer contact, customer phone number, customer email, date opened, date closed, initial severity, current severity, days since last update by support, product name, release number, problem description, current status, last update from customer, link to uploaded logs/data, and problem ticket history. However, it should be noted that illustrative embodiments may include more or less information in problem ticket fields 502 than illustrated. Input 504 represents data entries for respective item in problem ticket fields 502.

Illustrative embodiments store problem ticket 500 in a problem ticket tracking database, such as problem ticket database 310 in FIG. 3. In addition, illustrative embodiments may automatically identify quantitative metrics within input 504 corresponding to specified fields in problem ticket fields 502.

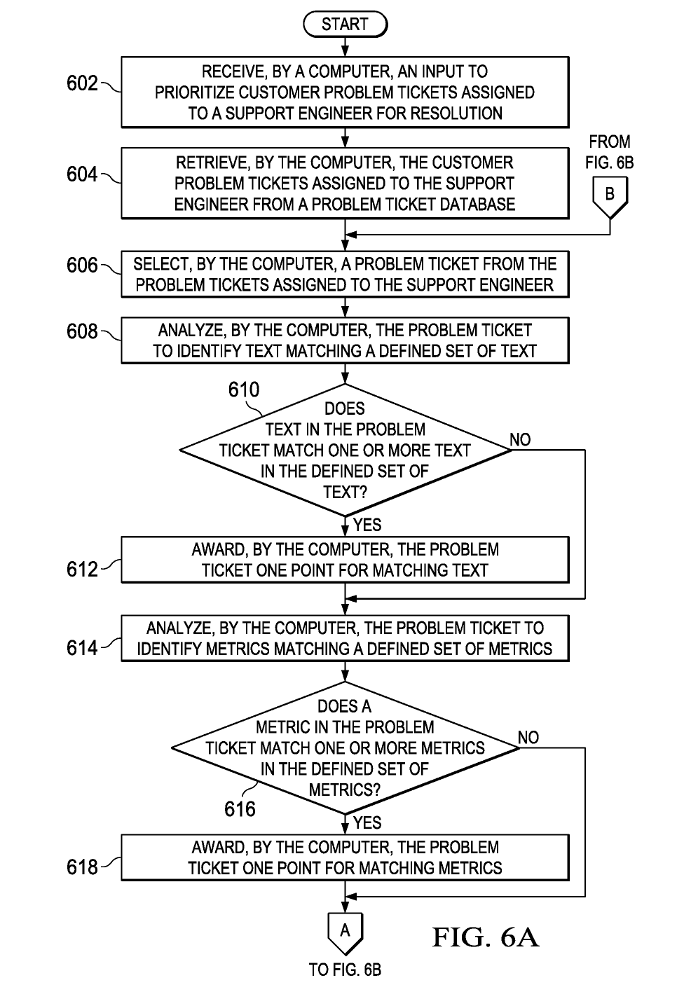

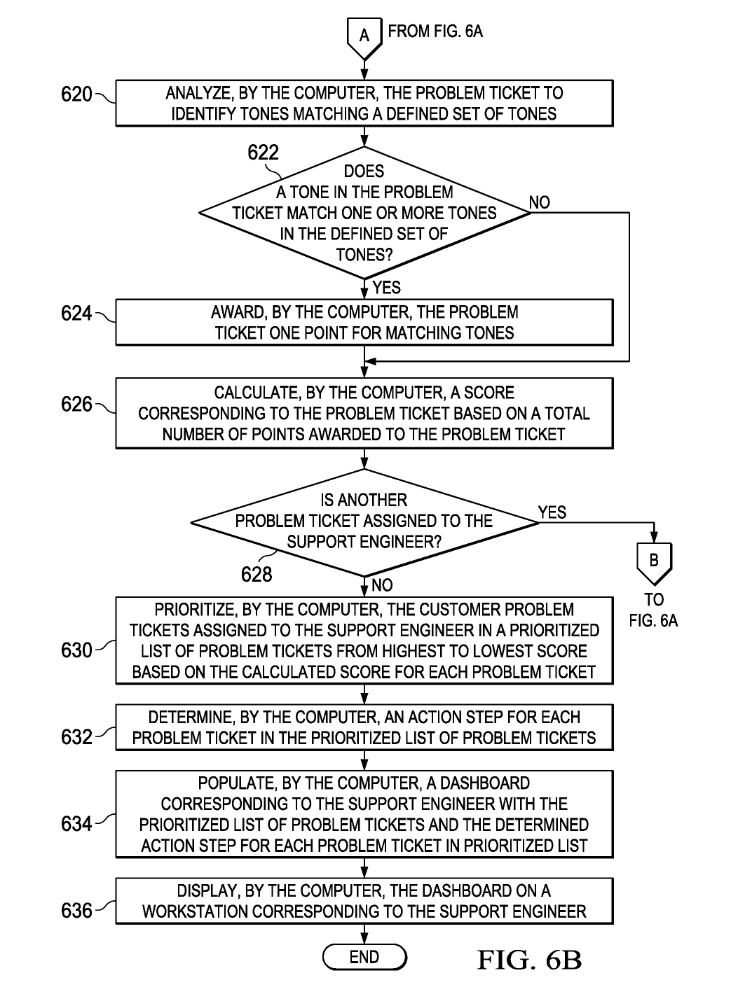

With reference now to FIGS. 6A-6B, a flowchart illustrating a process for populating a dashboard with a prioritized list of problem tickets and corresponding action steps is shown in accordance with an illustrative embodiment. The process shown in FIGS. 6A-6B may be implemented in a computer, such as, for example, server 104 or client 110 in FIG. 1 or data processing system 200 in FIG. 2.

The process begins when the computer receives an input to prioritize customer problem tickets assigned to a support engineer for resolution (step 602). The computer may receive the input to prioritize the problem tickets from a problem ticket manager, such as problem ticket manager 218 in FIG. 2. Alternatively, the computer may receive the input to prioritize the problem tickets from a workstation corresponding to the support engineer, such as client 110 in FIG. 1 or workstation 302 in FIG. 3. The support engineer may be, for example, user 306 in FIG. 3.

After the computer receives the input to prioritize the problem tickets in step 602, the computer retrieves the customer problem tickets assigned to the support engineer from a problem ticket database, such as problem ticket database 310 in FIG. 3 (step 604). The computer also selects a problem ticket, such as problem ticket 220 in FIG. 2 or problem ticket 316 in FIG. 3, from the problem tickets assigned to the support engineer (step 606). In addition, the computer analyzes the problem ticket to identify text matching a defined set of text, such as set of text 334 in FIG. 3 (step 608).

Subsequently, the computer makes a determination as to whether text in the problem ticket matches one or more text in the defined set of text (step 610). If the computer determines that no text in the problem ticket matches one or more text in the defined set of text, no output of step 610, then the process proceeds to step 614. If the computer determines that text in the problem ticket does match one or more text in the defined set of text, yes output of step 610, then the computer awards the problem ticket one point for the matching text (step 612).

Further, the computer analyzes the problem ticket to identify metrics matching a defined set of metrics, such as set of metrics 326 in FIG. 3 (step 614). Afterward, the computer makes a determination as to whether a metric in the problem ticket matches one or more metrics in the defined set of metrics (step 616). If the computer determines that no metric in the problem ticket matches one or more metrics in the defined set of metrics, no output of step 616, then the process proceeds to step 620. If the computer determines that a metric in the problem ticket does match one or more metrics in the defined set of metrics, yes output of step 616, then the computer awards the problem ticket one point for the matching metrics (step 618).

Furthermore, the computer analyzes the problem ticket to identify tones matching a defined set of tones, such as set of tones 336 in FIG. 3 (step 620). Subsequently, the computer makes a determination as to whether a tone in the problem ticket matches one or more tones in the defined set of tones (step 622). If the computer determines that no tone in the problem ticket matches one or more tones in the defined set of tones, no output of step 622, then the process proceeds to step 626. If the computer determines that a tone in the problem ticket does match one or more tones in the defined set of tones, yes output of step 622, then the computer awards the problem ticket one point for the matching tones (step 624).

The computer calculates a score corresponding to the problem ticket, such as problem ticket score 342 in FIG. 3, based on a total number of points awarded to the problem ticket (step 626). The computer also makes a determination as to whether another problem ticket is assigned to the support engineer (step 628). If the computer determines that another problem ticket is assigned to the support engineer, yes output of step 628, then the process returns to step 606 where the computer selects another problem ticket assigned to the support engineer. If the computer determines that no other problem ticket is assigned to the support engineer, no output of step 628, then the computer prioritizes the customer problem tickets assigned to the support engineer in a prioritized list of problem tickets from highest to lowest score based on the calculated score for each problem ticket (step 630). The prioritized list of problem tickets may be, for example, prioritized list of problem tickets 344 in FIG. 3.

Moreover, the computer determines an action step for each problem ticket in the prioritized list of problem tickets (step 632). The action step may be, for example, action 234 in FIG. 2. Afterward, the computer populates a dashboard corresponding to the support engineer with the prioritized list of problem tickets and the determined action step for each problem ticket in prioritized list((step 634). The dashboard corresponding to the support engineer may be, for example, dashboard 402 in FIG. 4. In addition, the computer displays the dashboard on the workstation corresponding to the support engineer (step 636). Thereafter, the process terminates.

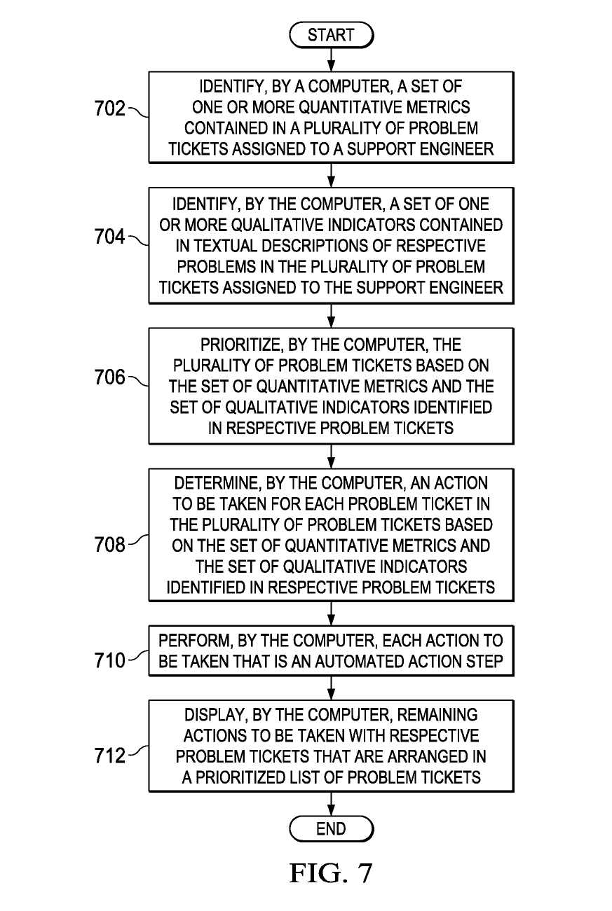

With reference now to FIG. 7, a flowchart illustrating a process for performing an automated action step is shown in accordance with an illustrative embodiment. The process shown in FIG. 7 may be implemented in a computer, such as, for example, server 104 or client 110 in FIG. 1 or data processing system 200 in FIG. 2.

The process begins when the computer identifies a set of one or more quantitative metrics contained in a plurality of problem tickets assigned to a support engineer (step 702). In addition, the computer identifies a set of one or more qualitative indicators contained in textual descriptions of respective problems in the plurality of problem tickets assigned to the support engineer (step 704). Further, the computer prioritizes the plurality of problem tickets based on the set of quantitative metrics and the set of qualitative indicators identified in respective problem tickets (step 706). Furthermore, the computer determines an action to be taken for each problem ticket in the plurality of problem tickets based on the set of quantitative metrics and the set of qualitative indicators identified in respective problem tickets (step 708). Moreover, the computer performs each action to be taken that is an automated action step (step 710). The computer also displays remaining actions to be taken with respective problem tickets that are arranged in a prioritized list of problem tickets (step 712). Thereafter, the process terminates.

Thus, illustrative embodiments of the present invention provide a computer implemented method, computer system, and computer program product for increasing the efficiency and effectiveness of a support engineer in resolving issues corresponding to a plurality of problem tickets by prioritizing the plurality of problem tickets assigned to the support engineer based on identifying and scoring quantitative metrics, qualitative indicators, and tone of customers in content of respective problem tickets and determining an action step for each respective problem ticket. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer-implemented method for determining next actions for resolution of a plurality of problem tickets, comprising:
identifying, by a computer, a set of quantitative metrics corresponding to the plurality of problem tickets;
identifying, by the computer, a set of qualitative indicators corresponding to the plurality of problem tickets, wherein each of the plurality of problem tickets contains textual descriptions of respective problems;
prioritizing, by the computer, the plurality of problem tickets based on the set of quantitative metrics and the set of qualitative indicators; and
determining, by the computer, a next action to be taken for each of the plurality of problem tickets based on the set of quantitative metrics and the set of qualitative indicators.

2. The computer-implemented method of claim 1, wherein the computer identifies the set of qualitative indicators by performing text analytics on the textual descriptions of the respective problems.

3. The computer-implemented method of claim 1, wherein the identifying of the set of qualitative indicators includes the computer identifying a tone expressed in a problem ticket by a submitter.

4. The computer-implemented method of claim 1, wherein the computer automatically performs the next action to be taken.

5. The computer-implemented method of claim 1, wherein the set of quantitative metrics correspond to predefined fields in a problem ticket.

6. The computer-implemented method of claim 1 further comprising:
analyzing, by the computer, a problem ticket to identify text matching a predefined set of text;
determining, by the computer, whether text in the problem ticket matches one or more text in the predefined set of text; and
responsive to the computer determining that text in the problem ticket matches one or more text in the predefined set of text, awarding, by the computer, the problem ticket one point for having text matching the predefined set of text.

7. The computer-implemented method of claim 1 further comprising:
analyzing, by the computer, a problem ticket to identify metrics matching a predefined set of metrics;
determining, by the computer, whether a metric in the problem ticket matches one or more metrics in the predefined set of metrics; and
responsive to the computer determining that a metric in the problem ticket matches one or more metrics in the predefined set of metrics, awarding, by the computer, the problem ticket one point for having metrics matching the predefined set of metrics.

8. The computer-implemented method of claim 1 further comprising:
analyzing, by the computer, a problem ticket to identify tones matching a predefined set of tones;
determining, by the computer, whether a tone in the problem ticket matches one or more tones in the predefined set of tones; and
responsive to the computer determining that a tone in the problem ticket matches one or more tones in the predefined set of tones, awarding, by the computer, the problem ticket one point for having tones matching the predefined set of tones.

9. The computer-implemented method of claim 1 further comprising:
calculating, by the computer, a score for a problem ticket based on a total number of points awarded to the problem ticket by the computer.

10. The computer-implemented method of claim 9 further comprising:
placing, by the computer, the plurality of problem tickets in a prioritized list of problem tickets from highest to lowest score based on the score calculated for each problem ticket.

11. The computer-implemented method of claim 10 further comprising:
populating, by the computer, a dashboard with the prioritized list of problem tickets and the next action to be taken corresponding to each respective problem ticket in the plurality of problem tickets; and
displaying, by the computer, the dashboard on a workstation.

12. A computer system for determining next actions for resolution of a plurality of problem tickets, the computer system comprising:
a bus system;
a storage device connected to the bus system, wherein the storage device stores program instructions; and
a processor connected to the bus system, wherein the processor executes the program instructions to:
identify a set of quantitative metrics corresponding to the plurality of problem tickets;
identify a set of qualitative indicators corresponding to the plurality of problem tickets, wherein each of the plurality of problem tickets contains textual descriptions of respective problems;
prioritize the plurality of problem tickets based on the set of quantitative metrics and the set of qualitative indicators; and
determine a next action to be taken for each of the plurality of problem tickets based on the set of quantitative metrics and the set of qualitative indicators.

13. The computer system 12, wherein the set of qualitative indicators is identified by performing text analytics on the textual descriptions of the respective problems.

14. The computer system 12, wherein identifying the set of qualitative indicators includes identifying a tone expressed in a problem ticket by a submitter.

15. The computer system 12, wherein the processor further executes the program instructions to automatically perform the next action to be taken.

16. A computer program product for determining next actions for resolution of a plurality of problem tickets, the computer program product comprising a computer readable storage medium having program instructions embodied therewith, the program instructions executable by a computer to cause the computer to perform a method comprising:
identifying, by the computer, a set of quantitative metrics corresponding to the plurality of problem tickets;
identifying, by the computer, a set of qualitative indicators corresponding to the plurality of problem tickets, wherein each of the plurality of problem tickets contains textual descriptions of respective problems;
prioritizing, by the computer, the plurality of problem tickets based on the set of quantitative metrics and the set of qualitative indicators; and
determining, by the computer, a next action to be taken for each of the plurality of problem tickets based on the set of quantitative metrics and the set of qualitative indicators.

17. The computer program product of claim 16, wherein the computer identifies the set of qualitative indicators by performing text analytics on the textual descriptions of the respective problems.

18. The computer program product of claim 16, wherein the identifying of the set of qualitative indicators includes the computer identifying a tone expressed in a problem ticket by a submitter.

19. The computer program product of claim 16, wherein the computer automatically performs the next action to be taken.

20. The computer program product of claim 16, wherein the set of quantitative metrics correspond to predefined fields in a problem ticket.
